(19) United States
(12) Patent Application Publication
(10) Pub. No.: US 2016/0005010 A1
(43) Pub. Date: Jan. 7, 2016

(54) Mi2CENTS SOCIAL MEDIA PLATFORM

(71) Applicant: Vincent Brown, Las Vegas, NV (US)

(72) Inventor: Vincent Brown, Las Vegas, NV (US)

(21) Appl. No.: 14/789,541

(22) Filed: Jul. 1, 2015

Related U.S. Application Data
(60) Provisional application No. 62/019,673, filed on Jul. 1, 2014.

(51) Int. Cl. G06Q 20/10; G06Q 20/24

(52) U.S. Cl. CPC G06Q 20/10; G06Q 20/24

(57) ABSTRACT

Embodiments relate to a computer implemented method operating on at least one central server enabling communication between social media participants in exchange for economic benefits, the computer implemented method including receiving at the at least one central server an original publication by an originating member using a first user interface device in communication with the at least the at least one central server; publishing the original publication at least one central server; receiving at the at least one central server at least one response to the published original publication by at least one of a plurality of user members; publishing the at least one response at the least one central server; crediting an account of the originating member based on the reception of the at least one response; and enabling the originating member at the central server to use account credits to initiate a purchase of at least third party offer.

### CROSS REFERENCE TO RELATED APPLICATION

This application claims the benefit of U.S. Provisional Application No. 62/019,673 filed Jul. 1, 2014 titled “Mi2Cents Social Media Platform” the complete subject matter of which is incorporated herein by reference.

### FIELD OF THE INVENTION

The present invention is in the technical field of social media. More specifically the Mi2Cent social platform is a World Wide Web Platform business model application that is custom made coded software that may or may not be used on the Cloud Network, permitting several alternatives to preface the tentative stating of one's opinion through on-line personal computers and mobile wireless devices used by advanced technology similar to those used for social media sites like Facebook, MySpace, and YouTube, and the like.

### BACKGROUND OF THE INVENTION

Currently, there are many on-line social media forum sites that are limited. First, there is no monetary reward value system available for on-line user members who wish to freely provide their opinions on various topics of information through postings on-line. Any on-line user can give away valuable free personal and non-personal information through postings that others can see and share for free without ever once getting rewarded from doing so. Second, today's social media sites represent an “invitation” to converse without the users really being able to earn a personal financial reward they can use for posting what they want to share. The Mi2Cent business model platform encourages the behavior of its users to give their opinions through its “Incentive Rewards Program”. Most social media sites are mostly a one-way street where users post various comments, photos, videos, and up-dates etc. without ever truly being encouraged to have an open honest dialog of getting other opinions based on what they really think. Third, there's no actual reward system in place for mobile wireless smart phone users who down load mobile apps and website links onto their mobile wireless device that will connect them directly to an advertisers websites.

With smartphones now passing PC global shipping numbers for the first time in history Mi2Cent has created an attractive new business model platform strategy that offers any smartphone user a way to rack up virtual dollars that can be exchanged into real dollar value items. The Mi2cent virtual bank money will be how user members redeem their Free Gift Cards, Coupons, and Rewards from various advertising companies we'll be doing business with.

### SUMMARY OF THE INVENTION

Embodiments relate to a system with at least one central server. The at least one server device includes processors, memory, databases including a non-transitory computer readable recoding medium and having stored there on computer-executable instructions that, in response to execution, execute a method adapted to enable communication between social media participants in exchange for economic benefits. In at least one embodiment, an original publication is created by an originating member using a first user interface device for example communicating with at least the at least one central server. The original publication is published by the at least one central server. The published original publication may be read by a plurality of user members using a plurality of user interface devices communicating with at least the at least one central server. At least one response to the published original publication is created by at least one of the plurality of user members using user interface devices for example. The at least one response is published by the at least one central server. The at least one central server credits an account of the originating member on the server by a predetermined amount for each published response. The system enables the originating member to purchase at least one of a product and service offered through the at least one central server by a provider.

Another embodiment relates to a tangible, non-transitory computer readable media comprising machine-readable executable code operable on at least one central server. The machine-readable executable code causes the at least one central server to receive an original publication by an originating member using a first user interface device in communication with at least the at least one central server; and publish the original publication at the at least one central server. At least one response is received at the at least one central server in response to the published original publication by at least one of a plurality of user members; the at least one response is published at the least one central server; and an account of the originating member is credited.

Another embodiment relates to a computer implemented method operating on the at least one central server enabling communication between social media participants in exchange for economic benefits. The computer implemented method includes creating an original publication by an originating member using a first user interface device communicating with at least the at least one central server; and publishing the original publication by the at least one central server. The method further includes reading the published original publication by a plurality of user members using a plurality of user interface devices communicating with at least the at least one central server and creating at least one response to the published original publication by at least one of the plurality of user members. The method includes publishing the at least one response by the at least one central server. The account of the originating member is credited a predetermined amount for each published response; enabling the originating member to purchase at least one of a product and service offered through the at least one central server.

Another embodiment relates to a computer implemented method operating on at least one central server enabling communication between social media participants in exchange for economic benefits, the computer implemented method including receiving at the at least one central server an original publication by an originating member using a first user interface device in communication with that at least the at least one central server; publishing the original publication at least one central server; receiving at the at least one central server at least one response to the published original publication by at least one of a plurality of user members; publishing the at least one response at the least one central server; crediting an account of the originating member based on the reception of the at least one response; and enabling the originating member at the central server to use account credits to initiate a purchase of at least third party offer.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a high level block diagram of a system in accordance with one embodiment of the present invention;

FIG. 2 illustrates a high level flow diagram of a computer implemented method in accordance with one embodiment of the present invention;

FIG. 3 illustrates a high level flow diagram of another computer implemented method in accordance with one embodiment of the present invention;

FIG. 4 illustrates examples of ‘Penny Icon Symbols in accordance with one embodiment of the present invention; and

FIG. 5 illustrates an example of a Bank, Vault, or Penny Jar icon symbol in accordance with one embodiment of the present invention.

Throughout the various figures, like reference numbers refer to like elements.

### DETAILED DESCRIPTION OF PRESENTLY PREFERRED EMBODIMENTS

Embodiments of the present invention relate to a Mi2Cent on-line social media platform/site that will become the standard bearer for understanding various topics of information based on millions of opinions that may be rewarded for each opinion provided. It will be used to take the temperature of people across the world by giving them an opportunity to provide their opinions on any topic they choose such as Personal Feelings, Family, Stocks, Presidential Elections, Breaking News, Consumer Product Surveys, Religious Opinions and the like.

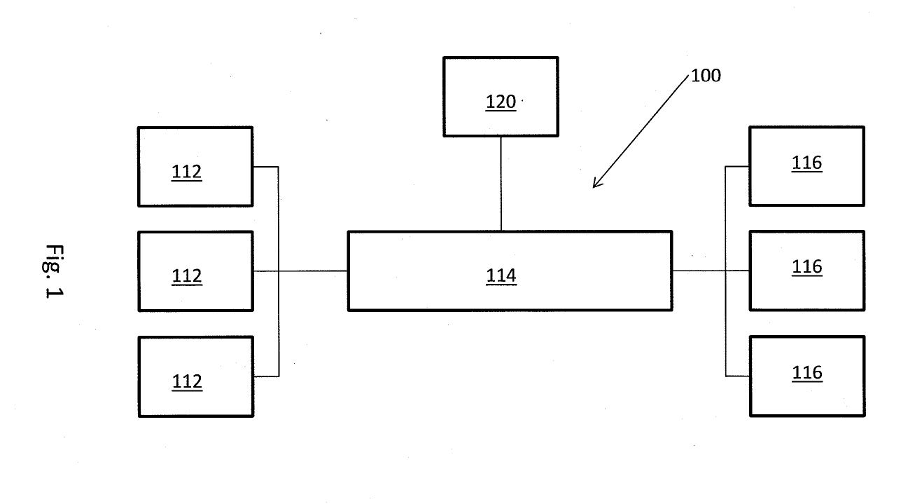

Embodiments relate to system 100 as illustrated in FIG. 1 implementing a computer implemented method using user interfaces 112 and/or 116 for example. System 100 includes a plurality of user interface devices 112 and 116 communicating with at least one or more central servers 114. In at least one embodiment, the user interface devices 112 and 116 include cell phones, smart phones, tablets, laptops, notebook computers, personal digital assistants, work stations, desktop computers, land line or hard wired phones, personal computers, stand alone computers, tower computers, cash registers, POP devices, smart card terminals, biometric scanners, cars, planes, trains, and the like which allow wired or wireless communication. Further, the devices 112 and 116 communicate with the at least one or more central servers 114 via any intranet, wired network, wireless network (Wi-Fi), satellite network, cellular network (3G, 4G, LTE) and the like. The user may access a website via user devices 112 and/or 116 to download an application operating on the user interface devices 112/116.

FIG. 1 further illustrates the at least one or more central servers 114. The at least one server device 114 includes processors, memory, databases including a non-transitory computer readable recoding medium and having stored there on computer-executable instructions that, in response to execution, execute a method adapted to enable communication between social media participants in exchange for economic benefits. In at least one embodiment, an original publication is created by an originating member using a first user interface device 112 for example communicating with at least the at least one central server 114. The original publication is published by the at least one central server 114. The published original publication may be read by a plurality of user members using a plurality of user interface devices 112/116 communicating with at least the at least one central server 114. At least one response to the published original publication is created by at least one of the plurality of user members using user interface devices 116 for example. The at least one response is published by the at least one central server 114. The at least one central server 114 credits an account of the originating member on the server by a predetermined amount for each published response. The system 100 enables the originating member to purchase at least one of a product and service offered through the at least one central server by a provider 120.

The following description is given as an example only and should not be seen in a limiting manner. Mi2Cent will provide a new state of the art website member sign up page and includes a web feature sub categories such as a Search Window, User Member Profile Page, Profile Picture, Mibrand, Miphoto, Mimeeting, Miphovid, MiNews, MiFriends, MiMail, MiBank, MiNotification, Mishare, MiOpinion, MiO, Michat, Miapps, Migames icon's, and the like.

All posting of opinions are accomplished by clicking or engaging the icon symbol “MiO” which enables users to enter their comments versus clicking a traditional “comment icon tab” symbol used on various other social media sites. “MiO” will be used in the place of the word “Comment”.

Friends or public user members respond to an originating members “Opinion” sent out for all on-line user members to see. Any response made using user interface devices 112 and/or 116 back to that originating members “Opinion” will automatically place 2¢ in the originating members Bank, Vault, or Penny Jar located on their front Profile Page or any other page. Any user member who wants to write a response to the originating members “Opinion” will need to click on the icon button “MiO” user interface 112 and/or 116 which opens a window for them to write their own opinion in response to the original opinion made.

Every time a user a member engages the “MiO” icon it opens up a window that says “Write an Opinion”. The first letter the user writes in their response opens the window to write a response, which includes a tab titled “MiPost”. When the user member engages “MiPost” it immediately logs their response opinion which triggers a mechanism adding 2¢ to the last 2¢ in the originating user members Bank, Vault, or Penny Jar, etc.

This window is where the “MiO” comments from other user members who've responded to an original opinion are found. These “MiO” comments include the user members profile name and response comment.

Another way user members add 2¢ to their user member bank vault includes user members clicking the Penny Icon Symbol tab using user interface 112 and/or 116 for example. The Penny Icon Symbol has the same effect as a thumbs up sign, representing approval. Clicking on the Penny Icon Symbol tab activates a mechanism that triggers an automatic placing of 2¢ in that originating user members Bank, Vault or Penny Jar etc.

The system 100 provides numerous other windows with various specific features for the user interface devices 112 and/or 116. In one example Mi2cent User members news feed provides a continuous non-stop streaming of other on-line user members postings that may be located under the “MiNews” icon symbol or other icon symbols. It may be located on the page of user interface devices 112 and/or 116 where all user members wanting to endorse the “MiO” can click on the Penny Icon Symbol that will be used like a thumbs up sign.

The Mi2cent Platform will be displayed under the heading tabbed “MiNews” located on the user interface 112 and/or 116 for example that will be considered the heading for all user members wanting to endorse other user member's opinions. Clicking on the “MiNews” tab will display a Penny Icon Symbol tab along with the “MiO” Icon tab and other possible tabs when opened.

Clicking on the Penny Icon Symbol and/or the MiO tab provides user members with only two of the ways user members can activate and trigger the automatic placement of 2¢ in an approve opinions made by other user members they're friends with.

### Example

### Symbols

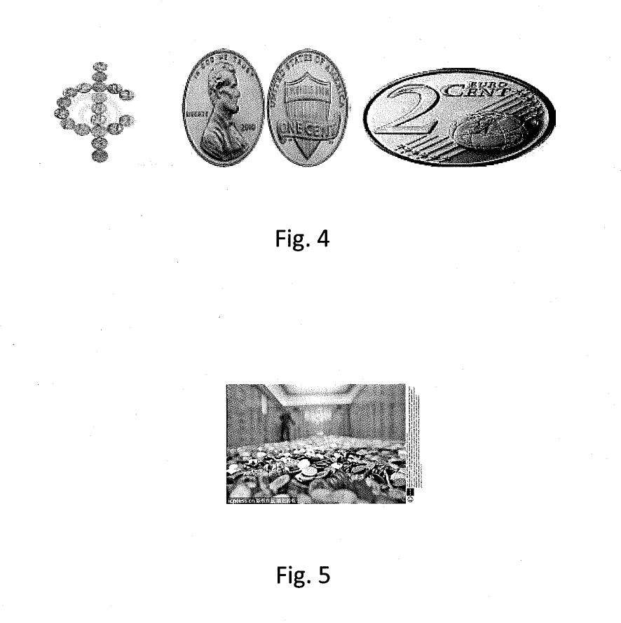

18 ¢ 3 MiO (See also FIG. 4)

Each Mi2Cent user member's front wall page includes a distinctive icon symbol such as a Bank, Vault, or Penny Jar as shown in FIG. 5. Inside each user member's bank vault is a non-stop visual tabulation mechanism that automatically calculates the adding of money from other user members “MiO” responses or engages of the Penny Icon Symbol.

The Mi2cent Platform is not limited to only using 2¢ in its activation methodology for placing coins or bills in user members virtual bank accounts based on user members MiO's. The Mi2cent Platform may use any denomination value for COINS and BILLS as ways to implementing the activation method of placing money in an originating user members Bank, Vault or Penny Jar etc. There different value denomination figure amounts that Mi2cent may us include $1, 5¢, $10, 9¢, $100, 20¢ and the like. If a user member doesn't have enough money in their virtual bank to qualify them for the Free Gift Cards/Coupons/Rewards they won't be able to receive the Free Gift Cards/Coupons/Rewards until they meet that requirement amount. s

Any user member can use the “Mishare” icon tab which allows them to receive virtual money from other user member's bank vaults by answering other user members “MiO” statements. When responding to other user member's “MiO's” they can add the “Mishare” Request Symbol that will include their request for money to be transferred into their own virtual bank account.

User members receiving the “Mishare” request don't have to give away any money if they don't want. The purpose of the “Mishare” feature is designed for all user members who want to offer money from their own virtual bank account to help other user members in a charitable way who don't have enough money in their own virtual bank accounts to qualify for the Free Gift Card/Coupon/Rewards.

For example, user member John answers Victoria's “MiO” under the tab “MiPost” using user interface devices 112 and/or 116. Before John engages or engages the “MiPost” submit icon with his response he engages another tab labeled “Mishare”. “Mishare” provides a virtual symbol box in which John requests 40¢ from Victoria. Victoria can either deny the request or give John 40¢ from her own Virtual Bank via a virtual symbol box on Victoria's page. Accepting the request transfers 40¢ out of Victoria's Virtual Bank into John's Virtual Bank.

If the user members have any money left over in their bank vault after spending the required amount to obtain the Free Gift Card/Coupon/Rewards, such left over amount becomes the starting point for any additional accumulated money that user members “MiO's, Penny Icon endorsement engages will be added to. Each Free Gift Card, Coupon, and Rewards has various award amounts that user members will be required to reach in order to qualify for that particular reward.

For example Wal-Mart offers a $1 coupon for 50% off of dishwashing detergent. This coupon requires Mi2cent user members to have 100¢ in their virtual bank vault before being able to redeem the $1 coupon. Any user member who has 100 pennies in their virtual bank vault can now purchase the coupon and get 50% off the purchase price of the item. McDonalds may include 50¢ coupon for a double cheeseburger that requires “Mi2cent” user members to have 50¢ in their virtual bank vault in order to redeem the 50¢ coupon.

Mi2cent user members can print their coupons or have the coupons displayed on the mobile user interface devices 112/116 which can be scanned at merchant stores when they redeem their coupon. User members can purchase gift items earned on “Mi2cent” using devices 112 and/or 116 for example.

“Mi2cent” employs the latest technologies regarding scanning Bar Code/QR code processes for its user members' devices 112 and/or 116 so user members can redeem the items right off of their own mobile user interface devices 112 and/or 116 when they accumulate enough pennies to earn them the Rewards they've won.

The Mi2Cent PC & Mobile App embodiments include a separate in box message center called “Mibrand” whose main focus is centered on user members bragging about their favorite Brand/Brands, Products & Services. Any user member responding to the originating user members Mibrand opinion made it will add 2 cents to the originating user member's bank vault. Each time an opinion is provide about the originating member's favorite Brand/Brands, Products & Services their account is credited 2¢.

“Mi2cent” will offer advertiser's a way to publish their company links on Mi2cent Platform. For example Wal-Mart, Apple, and Microsoft may have a direct link on “Mibrand Message Center” where user members can click onto their company's home page directing them to any number of specific advertiser products via the “Mi2cent” social media platform.

In at least one embodiment, this would be considered a back channel for economic activity by Mi2cent user members that would lead to large volumes of on-line user members desiring to redeem rewards that would provide large amounts of value to companies that purchased ad space from Mi2cent. Product/service opinions made by Mi2cent user members will revolutionize opinion giving via the business model platform that encourages user members to recognize and brag on Products and Services.

The “Mi2cent” PC & Mobile app etc. can place the “Mibrand” icon tab on the page of user interface devices 112 and/or 116 for example. When tapped or engaged an array of various company Brands, Products & Services will pop up where advertiser companies who want their products displayed on the first page can pay a higher premium rate to assure they get the best ad spot location available.

For example “Amazon” has a book that the user members like. The book requires 1,000¢ for Mi2cent user members to be able to purchase the book. The user members can click a link for “Amazon” located under the “Mibrand” page where the user members can transfer 1,000¢ from their bank vault to an area designated on the “Amazon” website. Advertising companies may use any number of on-line transfer electronic systems on their website's that act as an acceptance terminal where Mi2cent user members can redeem their Free Gift Card/Coupon/Rewards.

Another embodiment relates to the “Incentive Reward Gift Card Program” may be implemented for user members to use a predetermined monetary value number system. When user members reach the predetermined award amounts listed below an electronic mechanism is activated triggering flashing lights, words that can say Gold, Platinum, or Diamond that include the dollar amount won.

Gold —$1

Platinum —$2

Diamond —$3

When any Mi2cent user member reaches one of the levels mentioned above the Mi2Cent user member will receive a Free Gift Card/Coupon/Reward from any number of advertising companies that Mi2Cent sells ad space to on its site, helping advertisers aim their ads at specific target groups of Mi2Cent user members' profile data. Mi2Cent will also make money through revenue-sharing agreements with developers who offer apps on Mi2Cent: Mi2Cent will hand over a certain amount of “public” profile data to the app makers, enabling them to personalize the experience of the app's end users.

One of the goals of Mi2Cent is to promote giving and receiving opinions in return for Free Gift Cards/Coupons/Rewards by selling big marketers volume impressions online, by running ads at their own site based not on keywords but on the actual tastes and preferences of Mi2Cent users. Mi2Cent data will contain not only the user's demographic data, but also data about their online and offline likes and dislikes and those of their family and friends.

Mi2Cent will use advertising methods that are unique to its own business model platform. User Members will have the ability to remove ads from their entire profile page on their PC/Mobile wireless device altogether by opting to block ads under the “Privacy Settings” page where it might say “Option Out”. When on-line user member's sign up they will have this option available to them. For those who wish to exercise this feature they will not be able to access any of the actual benefits that “Mi2cent” Free Gift Cards/Coupons/Rewards Program offers and will be assured none of their personal information can or will be used by any of the advertising companies used by Mi2Cent Corporation.

At any time a user member can opt in to sign up for the Free Gift Cards/Coupons/Rewards Program even if they originally signed up under the Privacy “Option Out” Tab.

Once a Mi2Cent user member mentions they are a fan of “Nike” or any other sportswear brand for example, related ads will appear on their page for companies and websites selling them. Mi2Cent advertising system ensures that the right ad is displayed to the right customer, since the ads are selected for an individual page based on the interests and likes of the user by rewarding user members through advertiser Gift Cards, Coupons, and Rewards.

User members who select to take part in the Free Gift Cards/Coupons/Rewards Program will be informed of the Privacy Settings Page that any and all user member data will and can be used by Mi2cent Corporation, Advertising Companies, and any third party interest. This indicates how user members qualify using and spending virtual dollars on the Mi2cent Platform in being able to receive the Free Gift Cards, Coupons, and Rewards.

Facebook does “not currently directly generate meaningful revenue” from mobile devices, even though about half of its user base accesses Facebook from a mobile device. This is an important growth area for the future.

Mi2Cent will offer a new mobile wireless smart phone methodology for receiving hearing and communicating back and forth during actual live voice messaging in real time. Any land line or smart phone user that carries the Mi2Cent app will be able to call another land line or mobile wireless smart phone device that replays an analog or digital recording of a user's voice mail message.

Any time during a voice mail message that's being left by the caller on another person's land line or mobile wireless smart phone device where a person who's receiving that call on their land line or smart phone device can now Voice Activate and start talking directly to the caller via intercom by saying, “Mi2Cent” or something to that affect. The user member can be anywhere within a certain range of distance set forth by “Mi2cent” Company when answering the land line or mobile wireless smart phone device in real time as its ringing and not have to get up to answer it physically once the user member's activate the “Mi2Cent”, “Voice Activation Mechanism Analog”.

The user members can either let it go to voice mail where the user members can hear what's being said from a land line or mobile wireless smart phone speaker device or the user members can interrupt their voice mail message by the caller who's leaving the user members a live message right as it's happening in real time by just saying, “Mi2Cent” vs. “Hello”.

Once the mobile wireless smart phone speaker application hears the user members say, “Mi2Cent” it will automatically activate a live talk mechanism in their mobile wireless smart phone device that lets the user members talk live to the person who just called.

In one embodiment the Mi2Cent PC & Mobile App will have a box titled: “Mimeeting”. With “Mimeeting” the user members can conduct their own webinars on the “Mi2cent” Platform. User Members can select whom they want to invite openly or privately through an automatic invitation registration process through modern technologies available to “Mi2cent”.

The user member engages the “Mimeeting” tab which opens a window the user member's can send to friends or initiate a public invitation from the “Mi2cent” Platform. In at least one embodiment it includes a customized fill-in the blanks section field. “Mi2cent” user members can register to attend by clicking the “MiRegister tab which may include a customized fill in the blanks section field.

There are a number of ways to start the webinar meeting. In one example a “Mi2cent” user members engages the “Mimeeting” tab opening a button that says “Begin Mimeeting” which starts the meeting. There will be numerous “Miscreen” options available to share screening with attendees. Additionally there will be numerous options for user members to choose various audio preference's once they've arrived such as computer mic speaker or call in through phone.

Every “Mimeeting” user member host that sets up a meeting will receive various quantities of Pennies transferred into their virtual bank vault after the meeting starts if they've chosen the “Opt-In Requirement Choice Selection” under the “Privacy Settings” page which allows them to participate in the Free Gift Cards/Coupons/Rewards Program. Any user member who hasn't chosen the “Opt-In Requirement Choice Selection” to receive Free Gift Cards, Coupons, and Rewards can still partake in the “Mimeeting” Webinar operational function however they won't be able to access any of the actual the “Mi2cent” Free Gift Cards/Coupons/Rewards Program Offers.

The Mi2Cent PC & Mobile App includes a profile page with area's such as a Search Window, Member Profile icon, Mibrand, Miphoto, Mimeeting, Miphovid, MiNews, MiFriends, MiMail, MiBank, MiNotification, MiOpinion icon's, etc. Mi2cent will offer value reward incentives for all opinion responses made.

Mi2cent advertising rewards program opens its on-line business model platform to any and all companies who wish to purchase advertising slots by offering Mi2cent user members Free Gift Cards/Coupons/Rewards in exchange for getting the chance to advertise their companies' products to the tens of millions of Mi2Cent on-line user members. Companies can opt to purchase ad space on Mi2cent user page's or sign on for premium advertising platform packages. The Mi2cent advertising platform package will allow companies to place ads in the running streams of Mi2cent window's such as MiNews, MiMail, Mibrand, icon's and the like, both on their user interface device 112/116.

Mi2cent ads on MiNews, MiMail, and Mibrand icons will link to specific areas of another app on a user's interface device 112/116 based on what it is a friend made an “Opinion” about. For example a friend takes a video with Viddy. Viddy could pay Mi2cent to create a special type of “OPINION LINK.” When the friend engages the special “MiO” Link” his or her video from Viddy on Mi2cent will create a link that, when engaged, links them directly to that specific video within the Viddy app (assuming it's installed on the user's phone or PC, otherwise, it would link to the app store). This could be the same for many types of apps stored on a user's interface device 112/116: For example, reading and purchasing a book from “Amazon”. Let's say a Mi2cent user member engages the special “OPINION LINK” of his or her favorite book via “Amazon”, then clicking on it brings the user to the exact book the opinion was made about on “Amazon” website.

Mi2cent gets paid for the promotion and App developers would benefit by having Mi2cent users being directed to specific and relevant places in their apps (or if the user doesn't have the app, Mi2cent can link them directly to the App Store). These are just a few examples for multiple mobile app types.

The Mi2Cent will offer Live on-line mobile wireless smart phone video stream platforms through streaming servers capable of delivering Live video streams on demand. Mi2Cent Live on-line mobile wireless users will operate in the same manner as the non-video stream Mi2Cent business platform where friends or public user members can give their “Opinions” which places 2¢ in the originator members Bank, Vault, or Penny Jar.

Using the Penny Icon Symbol for user members responding back to the originating members Live on-line mobile wireless smart phone video stream. Mi2Cent users will still have to click on their “MiO” icon symbol when making a response to the Live video stream continent that's being shown.

Mi2cent Live will offer In-stream ad commercial videos that will appear before the user so they may watch an Internet video. The in-stream video ad commercials can last from anywhere from 10-30 seconds or whatever time increment Mi2cent selects to use.

For example, the user scrolls through the Mi2cent Live Feed to see what friends and family or other user members are putting up in real time and in-stream ads are peppered into the Feed.

When any Mi2Cent member responds to another Mi2Cent members Live video stream by engaging the Penny Icon Symbol, such response triggers an automatic placing of 2¢ in that user members Bank, Vault or Penny Jar. Every response keeps adding 2¢ onto the last 2¢ in that user members Bank, Vault, or Penny Jar until it accumulates and reaches a predetermined monetary value number. When the predetermined monetary value number is reached it triggers a flashing light with words that can say Gold, Platinum, or Diamond based on the specific dollar amount that is reached below:

Mi2Cent—Incentive Reward Gift Card Program

Gold —$1

Platinum —$2

Diamond —$3

The Mi2Cent Live on-line mobile wireless smart phone video stream component on one or more user interface devices 112/116 will operate in the same fashion to encourage the behavior of its user members to provide their opinions via Live video stream “Opinions” to participate in the “Incentive Rewards Program”.

Mi2Cent Live video stream user members will receive Free Gift Cards, Coupons and Rewards from any number of advertising companies that Mi2Cent sells ad space to on its site, helping advertisers to forget their ads at specific groups of Mi2Cent user members, based on elements of members' profile data.

Alternatively the Mi2Cents Live Platform will offer its on-line mobile wireless smart phone users an “Alternative Option Selection Choice”. Operating in a similar manner and scope as the Mi2Cents/Live where friends or public user members can provide their “MiO or Penny Icon Symbol” responses for enabling other user members receives 2¢ added onto the last 2¢ in the originating members virtual bank accounts.

Mi2Cents/Live mobile app will include an “Option” tab for user's members who reach the winning predetermined monetary value number that Mi2Cents/Live offers user members Free Gift Cards, Coupons, and Rewards from advertisers once they reach the Gold, Platinum, or Diamond Levels.

When any on-line/mobile wireless user member reaches a winning level for the Free Gift Cards, Coupons, and Rewards Program a pop up window on their screen of their mobile user interface devices 112/116 will appear with two “Options” for them to choose from.

The window on the user's on-line mobile wireless device 112/116 will show an “Accept or Decline” icon symbol. If an on-line mobile wireless users engages the “Accept” icon symbol they will receive the Advertiser Company's Free Gift Card, Coupon, or Reward.

An ad from a company who is giving away the Free Rewards Gift Card will appear on the front screen of their mobile wireless user interface device 112/116 with the amount of the Free Rewards Gift Card, Coupon accessible by using banner ads, or visual QR codes (images that can be scanned from mobile user interface devices 112/116 like bar codes, and can be used like coupons for special offers, etc.

If an on-line mobile wireless user member wants to try for a higher Incentive Rewards Gift Card, Coupon at a later time and date they can chose the “Decline” icon symbol which will immediately return them to their original Mi2Cents/Live social media user member page. Once back on their Mi2Cents/Live user member page it will display the Incentive Rewards Gift Card level they are currently at including the amount of money they have accumulated in their user member Bank, Vault or Penny Jar.

By engaging the “Decline” icon symbol allows that user member to pass on the current Free Gift Card, Coupon, Rewards offer and try for the next highest level in the Free Rewards Gift Card Program to be offered at a later time and date. Reaching the next highest level will be based on that user member getting enough “MiO or Penny Icon Symbol” responses from other user members to accumulate 2¢ added onto the last 2¢ in that user member's virtual Bank, Vault or Penny Jar.

One embodiment includes Mi2Cent-Games Application Distribution and Monetization App Mi2cent Games Platform which allows on-line mobile wireless games to be played and shared across the Globe by user members, developers, publishers, and advertisers. It offers Free on-line mobile wireless casino games including casino table games, casino slot games and more such as Poker, Kino, Bingo, Black Jack, and Slots just to name a few.

The games have numerous variations, whether explicitly provided for by the specification or implied by the specification below regarding how the games can be played. The Mi2cent Games Platform may or may not be interconnected to the Mi2cent “Incentive Rewards Program Platform that includes Free Gift Cards, Coupons, and Rewards.

For example, Mi2cent Games will operate similarly under the same manner of technology regarding the activation methodology of placing 2¢ in an originating user members Bank, Vault or Penny Jar etc

All games will require using the 2¢ accumulation mechanism process that's used on the Mi2cent “Incentive Rewards Program Platform”. For example, using Poker games such as Texas Hold 'Em, Omaha, or the like, Mi2cent user members can invite real user members to play with them or play alone on a virtual computer assimilation portal with fictitious players versus real user member players. To initiate play user members will click on the “Migames” Icon Symbol tab to log in with their “Mi2cent” username and password.

Alternatively user members can also log in with their Google, Yahoo, Facebook or Twitter accounts etc. Once logged in the user members will see the user member's player profile image and other data that may include all favorite games and amount of Pennies the user member's have accumulated in their virtual bank account in the Mi2cent “Incentive Rewards Program” SITE. There'll be a number of ways for user members to communicate with multiple user members who want to play against each other in real time as bets are being wagered.

The money used to wage all bets with will come from all user members virtual bank accounts on their “Mi2cent “Incentive Rewards Program” Page. Money will be added and subtracted from this account according to the outcome for each hand or game played where user members can raise, call or fold depending on the type of game being played.

For example: Michael wins the pot in poker which has 8 user members playing in that game. Michael's beginning virtual bank account had $6 in it before he won the pot. After winning he now has $8 in his virtual bank account based on the bets of other user members Michael played against and won. Now let's say 3 user members used up all their accumulated Pennies in their Mi2cent virtual bank accounts during the game played. Those 3 user members profile image and names will disappear from the game portal altogether while the 5 user members who still have money in their virtual banks accounts will remain.

The Mi2Cent advertising marketing exchange process can work in the following manner. Mi2cent user members will see various advertiser rewards/coupons offered to them on the Mi2cent website that allows them to instantly connect to product and service discounts.

Advertising company's product and service discounts and rewards will be linked through QR Code/Bar Code's or the like displayed on the Mi2cent website when user members want to redeem savings from their mobile user interface devices 112/116 at merchant stores. The user member may have the cashier scan their QR Code/Bar Code or the like on their mobile devices 112/116, automatically adjusting their final purchase price to include the advertiser's rewards/coupon discount in the final tally.

Each time a Mi2cent user member redeems an advertisers reward or coupon discount via scanning their QR Code/Bar Code or the like they will automatically receive a predetermined set amount of virtual credits/dollars that will appear in their Mi2cent virtual bank account located on each Mi2cent user member's platform front page or the like.

A new Mi2cent user member who signs up will have zero credit/dollars in his or her virtual bank account on their own platform page. They can redeem any number of advertiser company rewards or coupon discounts offered on their front page at any time. “User Member 1” decides to redeem a discount offer from “Target” store who is offering 10% off “Tide Laundry Detergent”.

“User Member 1 goes up to the cash register attendant and shows their mobile user interface device 112/116 displaying discount QR Code/Bar Code or the like. The attendant scans the code right off their device. Once the scan is done it immediately lowers the original price of the washing detergent by 10% and at the same time “User Member 1” retains X amount of virtual credits/dollars in his or her online virtual bank account on the front page of their Mi2cent page.

For this example “User Member 1” who signed up as a new member has zero dollars in their virtual bank account. After making their first purchase with the 10% discount they now have $100 in virtual credits/dollars accumulated into their Mi2cent virtual bank account by activating the Mi2cent advertiser reward/coupon discount QR Code/Bar Code mechanism.

Another embodiment relates to advertising. “Miadds” relates to a marketing exchange process enabling Mi2cent user members to see various advertiser rewards/coupons offered to them on the Mi2cent website on user interface devices 112/116 for example, allowing them to instantly connect to product and service discounts.

Advertising company's product and service discounts and rewards will be linked through QR Code/Bar Code's or the like displayed on the Mi2cent website. User members who want to redeem savings from their mobile user interface devices 112/116 at merchant stores. They have the cashier scan their QR Code/Bar Code or the like on their mobile user interface devices 112/116 automatically adjusting their final purchase price to include the advertiser's rewards/coupon discount in the final tally.

Each time a Mi2cent user member redeems an advertisers reward or coupon discount via scanning their QR Code/Bar Code or the like, they automatically receive a predetermined set amount of virtual credits/dollars that will appear in their Mi2cent virtual bank account located on each Mi2cent user member's platform front page or the like.

A new Mi2cent user member who signs up will have zero credit/dollars in his or her virtual bank account on their own platform page. They can redeem any number of advertiser company rewards or coupon discounts offered on their front page at any time. User Member 1 decides to redeem a discount offer from “Target” store who is offering 10% off “Tide Laundry Detergent”.

User Member 1 goes up to the cash register attendant and shows their mobile discount QR Code/Bar Code or the like. The attendant scans the coupon right off their mobile user interface device 112/116. Once the scan is done it immediately lowers the original price of the washing detergent by 10% and at the same time “User Member 1” retains X amount of virtual credits/dollars in his or her online virtual bank account on the front page of their Mi2cent page.

One embodiment of the Mi2Cent platform website configures and integrates all type of other social media platform site features such as share photo, take photo, write post, like, photos, video's, comments, friends, Apps, Chats, followers, uploads, reviews and the like from sites such as Facebook, YouTube, Instagram, Twitter, Linkedin, Flipboard, Google+, and the like. This embodiment is titled: Mishuffle.

Mishuffle configures and adds to any and all social media site feature's simultaneously by cross promoting Mishuffle activities onto other social media website feature pages in real time. The Mishuffle app is found on Mi2cent website. Mishuffle app will use the system 100 to integrate, configure and transfer any of its online social media activities right into other social media site feature pages at the same time and point when being activated from the Mishuffle app located on the Mi2cent website.

For example, Sabina is a user member in addition to being a user member of such platforms as Facebook, Twitter, Google+, Instagram, and Youtube and shares photos and videos on those platforms with her friends. If Mi2cent user member Sabina wants to share a photo and/or video, she uploads the photo and/or video onto her Mi2cent page which shares them with her other social media sites such as Facebook, Twitter, Google+, Instagram, and Youtube, sending them to a few of hers friends on those other sites as well.

Alternatively Sabina goes to her Mi2cent user member profile page and clicks on the Miapps icon, which brings up the All Search window. Sabina types the word Mishuffle into the search window and all of her other social media site links she's a user member of pop up vertically as described below:

Facebook

Twitter

Google+

Instagram

Youtube

Etc.

Sabina clicks on each social media site she wants to share the uploaded photo and/or video's she's uploaded onto her Mi2cent page to her Facebook, Instagram, Google+ page windows for photos and videos all at the same time instantaneously. She now has to highlight each one she wants to share them with by clicking on the ones she wants to share with. Once they are highlighted, a friend's window pops up so that she can choose any of her friends from any of the sites her friends and her are joint members of. She chooses 2 friends one named Logan a friend on Facebook and one named Victoria a friend on Instagram.

Now that's she's done with her selection, she clicks the send icon tab and now her photo and video are both sent to each designated selection choice made above instantaneous in real time that she can cross check and see on any of her other social media sites that will show the same photo and video she just uploaded that's on her Mi2cent page under the Mishuffall app tab. The Mishuffall app will work with any online social media site where a Mi2cent user member can cross connect.

For example all #Hashtags, dating websites, coupons, rewards, vacation websites, airline websites, bank websites, businesses etc. can cross connect and share any and all types of information and data all at the same time like the above illustration without having to send each individual website the information one website at a time. They all can receive the same information or data at the same time using Mishuffall like in the example above.

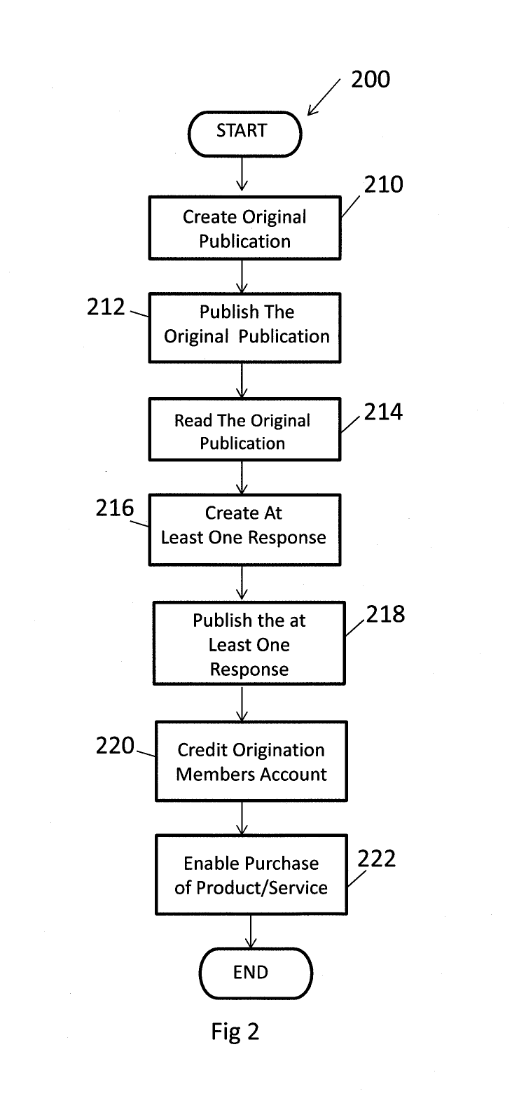

FIG. 2 illustrates another embodiment relating to a computer implemented method generally designated 200 operating on the at least one central server 100 enabling communication between social media participants in exchange for economic benefits. The computer implemented method includes creating an original publication by an originating member using a first user interface device communicating with at least the at least one central server, block 210; and publishing the original publication by the at least one central server, block 212. The method 200 further includes reading the published original publication by a plurality of user members using a plurality of user interface devices communicating with at least the at least one central server, block 214 and creating at least one response to the published original publication by at least one of the plurality of user members, block 216. The method includes publishing the at least one response by the at least one central server, block 218. The account of the originating member is credited a predetermined amount for each published response, block 220; enabling the originating member to purchase at least one of a product and service offered through the at least one central server, block 222.

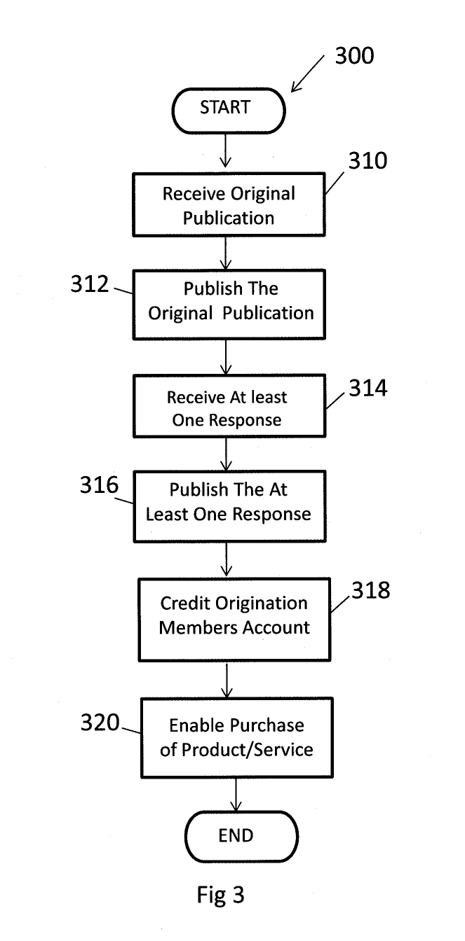

FIG. 3 illustrates another embodiment related to a computer implemented method generally designated 300 operating on at least one central server enabling communication between social media participants in exchange for economic benefits, the computer implemented method including receiving at the at least one central server an original publication by an originating member using a first user interface device in communication with that at least the at least one central server, block 310; and publishing the original publication at least one central server, block 312. The method 300 further includes receiving at the at least one central server at least one response to the published original publication by at least one of a plurality of user members, block 314; and publishing the at least one response at the least one central server block 316. Additionally, method 300 includes crediting an account of the originating member based on the reception of the at least one response, block 318; and enabling the originating member at the central server to use account credits to initiate a purchase of at least third party offer, such as through a third party link, block 320.

For this example “User Member 1” who just signed up as a new member signed up with zero dollars in their virtual bank account however after making their first purchase with the 10% discount they now have $100 in virtual credits/dollars accumulated into their Mi2cent virtual bank account by activating the Mi2cent advertiser reward/coupon discount QR Code/Bar Code mechanism.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

1. A computer implemented method operating on at least one central server enabling communication between social media participants in exchange for economic benefits, the computer implemented method comprising:
receiving at the at least one central server an original publication by an originating member using a first user interface device in communication with at least the at least one central server;
publishing the original publication at the at least one central server;
receiving at the at least one central server at least one response to the published original publication by at least one of a plurality of user members;
publishing the at least one response at the least one central server; and
crediting an account of the originating member.

2. The computer implemented method of claim 1 wherein crediting the account of the originating member is based on the receipt of the at least one response.

3. The computer implemented method of claim 1 wherein crediting the account of the originating member further comprises the at least one of a plurality of user members engaging an icon displayed on at least a second user device communicating with at least the at least one central server.

4. The computer implemented method of claim 1 further including enabling the originating member at the central server to use account credits to initiate a purchase of at least third party offer.

5. The computer implemented method of claim 4 wherein the third party offer further includes products or services.

6. The computer implemented method of claim 1 further comprising writing the at least one response by the at least one of a plurality of user members engaging an icon displayed on at least a second user device communicating with at least the at least one central server.

7. Tangible, non-transitory computer readable media comprising machine-readable executable code operable on at least one central server, the machine-readable executable code causing the at least one central server to:
receive at the at least one central server an original publication by an originating member using a first user interface device in communication with at least the at least one central server;
publish the original publication at the at least one central server;
receive at the at least one central server at least one response to the published original publication by at least one of a plurality of user members;
publish the at least one response at the least one central server; and
credit an account of the originating member.

8. The computer readable media of claim 7, wherein the machine-readable executable code is further operable to cause the at least one central server to credit the account of the originating member based on the receipt of the at least one response.

9. The computer readable media of claim 7, wherein the machine-readable executable code is further operable to cause the at least one central server to credit the account of the originating member when the at least one of a plurality of user members engages an icon displayed on at least a second user device communicating with at least the at least one central server.

10. The computer readable media of claim 7, wherein the machine-readable executable code is further operable to cause the at least one central server to enable the originating member to use account credits to initiate a purchase of at least third party offer.

11. The computer readable media of claim 10, wherein the machine-readable executable code is further operable to cause the at least one central server to offer third party products or services.

12. The computer readable media of claim 7, wherein the machine-readable executable code is further operable to cause the at least one central server to enable writing the at least one response by the at least one of a plurality of user members engaging an icon displayed on at least a second user device communicating with at least the at least one central server.

13. A computer implemented method operating on at least one central server enabling communication between social media participants in exchange for economic benefits, the computer implemented method comprising:
creating an original publication by an originating member using a first user interface device communicating with at least the at least one central server;
publishing the original publication by the at least one central server;
reading the published original publication by a plurality of user members using a plurality of user interface devices communicating with at least the at least one central server;
creating at least one response to the published original publication by at least one of the plurality of user member;
publishing the at least one response by the at least one central server;
crediting the account of the originating member a predetermined amount for each published response; and
enabling the originating member to purchase at least one of a product and service offered through the at least one central server.
